(19) United States
(12) Patent Application Publication
(10) Pub. No.: US 2016/0282373 A1
(43) Pub. Date: Sep. 29, 2016

(54) APPARATUS FOR PARALLEL PROCESSING OF SLIDE SPECIMENS IN RECEPTACLES

(71) Applicant: SYFR, INC., Danville, CA (US)

(72) Inventors: Shazi S. Iqbal, Danville, CA (US); Michael Mayo, Austin, TX (US); Paul Parks, Austin, TX (US); Alexander Greis, Austin, TX (US)

(21) Appl. No.: 15/079,011

(22) Filed: Mar. 23, 2016

Related U.S. Application Data
(60) Provisional application No. 62/137,221, filed on Mar. 23, 2015.

(51) Int. Cl. G01N 35/00; G01N 35/10

(52) U.S. Cl. CPC G01N 35/00029; G01N 35/1002; G01N 35/1065

(57) ABSTRACT

A test instrument includes multiple receptacle bays for testing specimens contained in specimen receptacles. The test instrument processes different specimens in different specimen receptacles in the respective receptacle bays in parallel. Different tests may be conducted in the receptacle bays at the same time. Each receptacle bay couples to one or more common bulk reagent stores and to one or more small volume reagent stores. This arrangement may provide a dramatic increase in specimen processing efficiency by enabling different tests to be conducted in each receptacle bay at the same time.

### CROSS REFERENCE TO RELATED PATENT APPLICATION AND PRIORITY CLAIM

This patent application claims priority to Provisional U.S. Patent Application Ser. No. 62/137,221, filed Mar. 23, 2015, inventors Shazi Iqbal et al., entitled “Parallel Processing Patient Specimen Apparatus”, which is incorporated herein by reference in its entirety.

### BACKGROUND

The disclosures herein relate generally to patient specimen testing, and more specifically to apparatus for more efficiently testing patient specimens. The testing of patient specimens requires a great deal of precision and accuracy, which necessarily consume a large amount of time in conventional patient specimen testing protocols. It is desirable to maintain this precision and accuracy while processing patient specimen more efficiently.

### BRIEF SUMMARY

In one embodiment, a self-contained sample processing receptacle (i.e. cartridge), is disclosed. The sample processing receptacle includes a first receptacle portion including a receiver that receives a specimen slide. The sample processing receptacle further includes a second receptacle portion that closes on the first receptacle portion to form a chamber interior to the receptacle, wherein the specimen slide forms a surface of the chamber. In one embodiment, the specimen slide forms one wall of the chamber to effectively complete the chamber. In one embodiment, the receiver of the first receptacle portion includes an open region adjacent in which the specimen slide is received. In one embodiment, the second receptacle portion includes a plurality of fluid inputs and at least one fluid output. The plurality of fluid inputs couples to the chamber by a plurality of channels respectively therebetween. In one embodiment, at least one of the plurality of channels includes a reagent reservoir. In one embodiment, at least one of the plurality of channels includes a blocking reservoir. It is noted that in one embodiment, the specimen to be processed can be adhered to a glass slide that forms one wall of the chamber. Alternatively, the specimen may not be adhered at all to the glass slide but can be contained in, or brought into, the chamber for processing during application of the disclosed receptacle processing procedure.

In another embodiment, a patient specimen processing apparatus is disclosed. This apparatus is also referred to as a test instrument. The specimen processing apparatus includes a plurality of specimen processing bays each capable of receiving a respective receptacle that includes a specimen slide, each receptacle including protocol specific reagents that are specific to a protocol of each slide. The apparatus also includes a plurality of common reagent stores accessible by each of the specimen processing bays to supply reagents to the specimen processing bays. In one embodiment, the plurality of common reagent stores is configured to supply reagents to the plurality of specimen processing bays in parallel. In another embodiment, the apparatus includes a plurality of multiple input valves, each multiple input valve being dedicated to a respective processing bay, each input of a particular multiple input valve being capable of selecting a different common reagent store.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1A is an exploded view of one embodiment of the disclosed sample processing receptacle (i.e. cartridge).

FIG. 1B is a top perspective view of one embodiment of the disclosed sample processing receptacle.

FIG. 1C is a plan view of one end of the disclosed sample processing receptacle.

FIG. 1D is a plan view of an opposite end of the disclosed sample processing receptacle.

FIG. 1E is a plan view of one side of the disclosed sample processing receptacle.

FIG. 1F is a plan view an opposite side of the disclosed sample processing receptacle.

FIG. 1G is a top plan view of one embodiment of the disclosed sample processing receptacle.

FIG. 1H is a bottom view of one embodiment of the disclosed sample processing receptacle showing a specimen slide forming one surface of the chamber thereof.

FIG. 1I is a top perspective view of one embodiment of the disclosed sample processing receptacle showing a hinge connecting the different portions of the receptacle together.

FIG. 2A is a top left side perspective view of one embodiment of the disclosed specimen processing apparatus.

FIG. 2B is a top right side perspective view of one embodiment of the disclosed specimen processing apparatus.

FIG. 2C is a top plan view of one embodiment of the disclosed specimen processing apparatus.

FIG. 2D is a front plan view of one embodiment of the disclosed specimen processing apparatus.

FIG. 2E is a left plan view of one embodiment of the disclosed specimen processing apparatus.

FIG. 2F is a back plan view of one embodiment of the disclosed specimen processing apparatus.

FIG. 2G is a right plan view of one embodiment of the disclosed specimen processing apparatus.

FIG. 2H is a bottom plan view of one embodiment of the disclosed specimen processing apparatus.

FIG. 3 is a block diagram of electrical systems included in one embodiment of the disclosed specimen processing apparatus.

FIG. 4 is a block diagram of fluidics in one embodiment of the disclosed specimen processing apparatus.

FIG. 5 is a high level flowchart depicting a representative process flow in one embodiment of the disclosed methodology.

### DETAILED DESCRIPTION

In one embodiment, a self-contained sample processing receptacle (i.e. cartridge) for holding a specimen during testing is disclosed. The receptacle includes a lower member with a slide receiver that receives a slide with a sample thereon. The receptacle also includes an upper member configured such that when the upper member is closed upon the lower member, a chamber is formed between the upper member and the lower member. The slide being situated within the sample processing receptacle effectively completes the receptacle chamber and provides one of the major surfaces of the receptacle chamber. The sample processing receptacle includes multiple fluid inputs and at least one fluid output. In one embodiment, the upper member of the receptacle includes multiple fluid channels. One or more of the fluid channels include reservoirs, such as reagent reservoirs and fluid blocking reservoirs, as explained in more detail below. In one embodiment, the user is provided with a complete receptacle assembly except for the glass slide on which the specimen is placed. The reservoirs in the channels of the receptacle assembly are preloaded with reagents required for the particular testing protocol corresponding to the sample on the glass slide of the receptacle. Such reagents may include antibodies, DNA/RNA oligonucleotides and enzymes. When the user places the glass slide in the lower member and closes the upper member, the glass slide forms one of the interior walls of the sealed chamber.

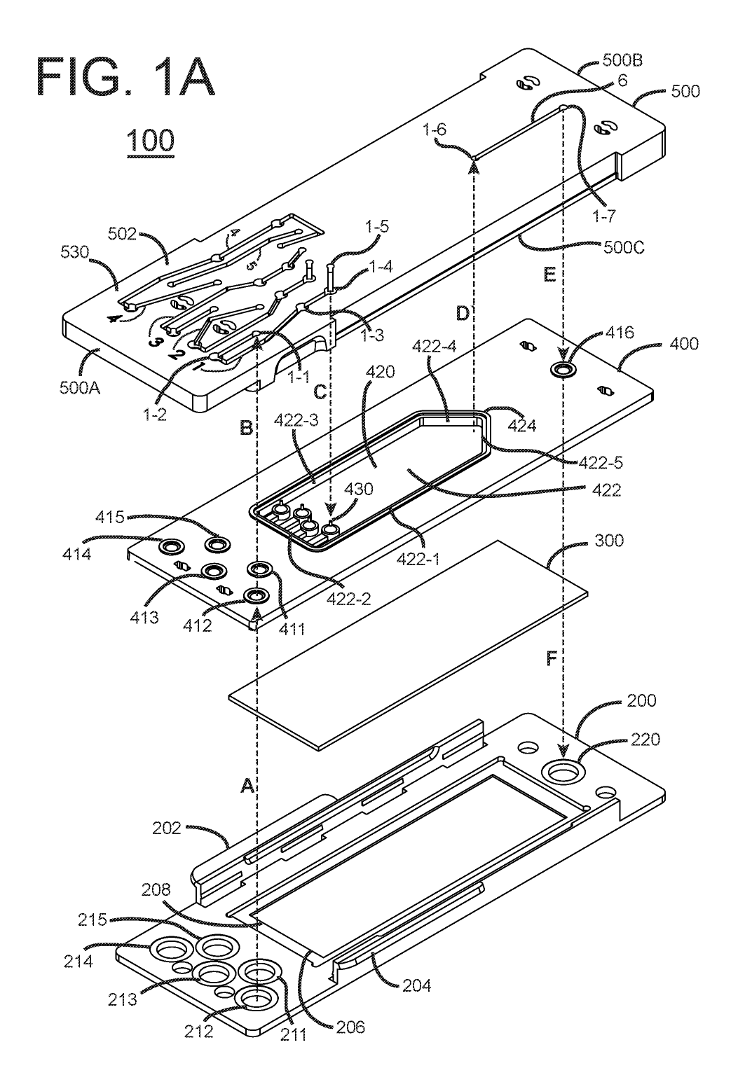

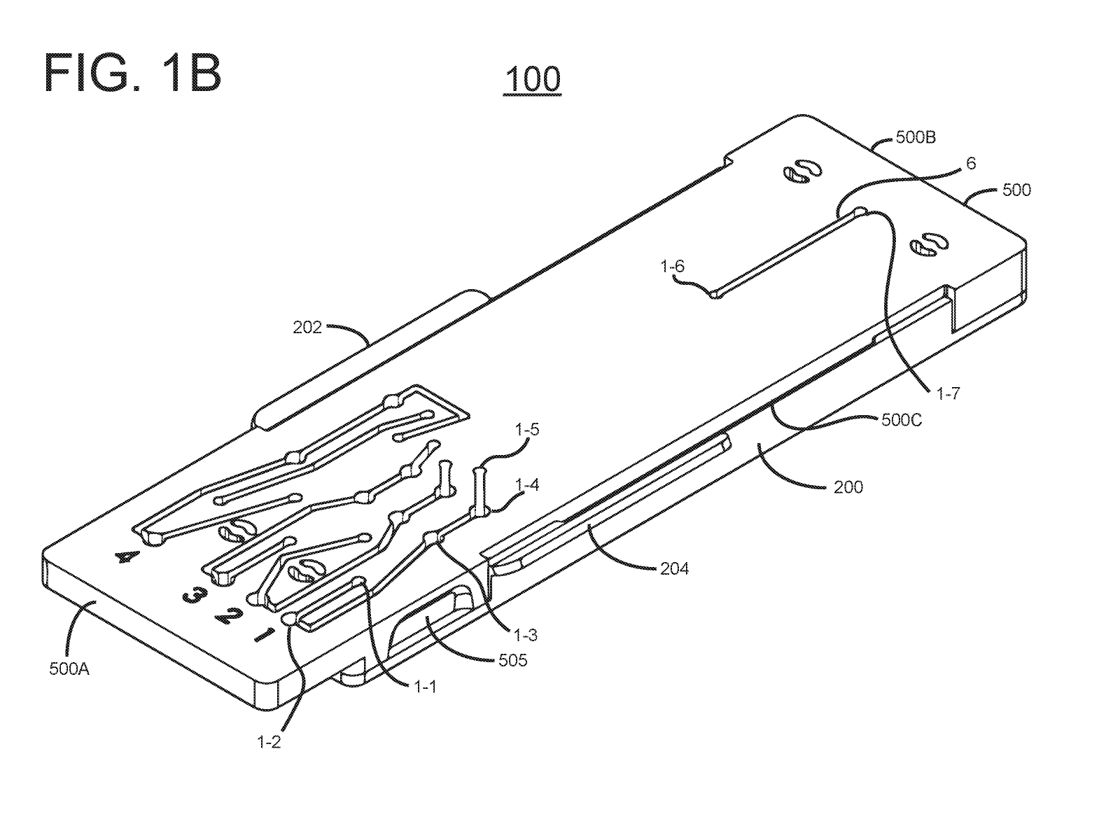

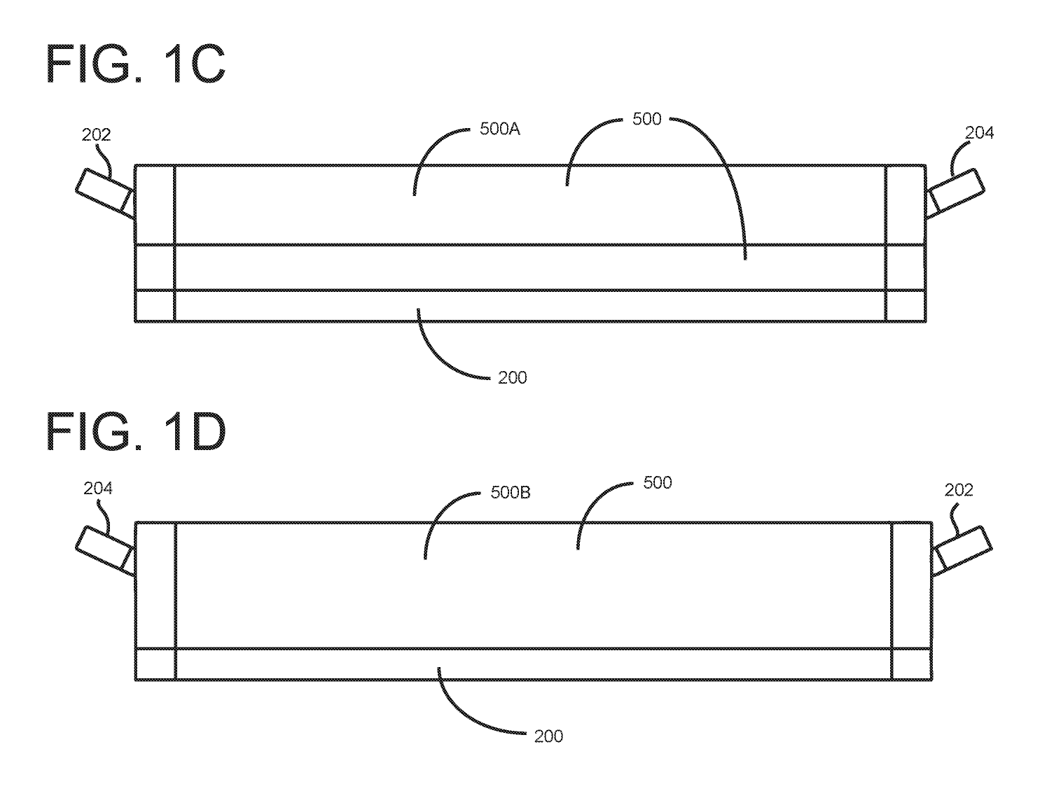

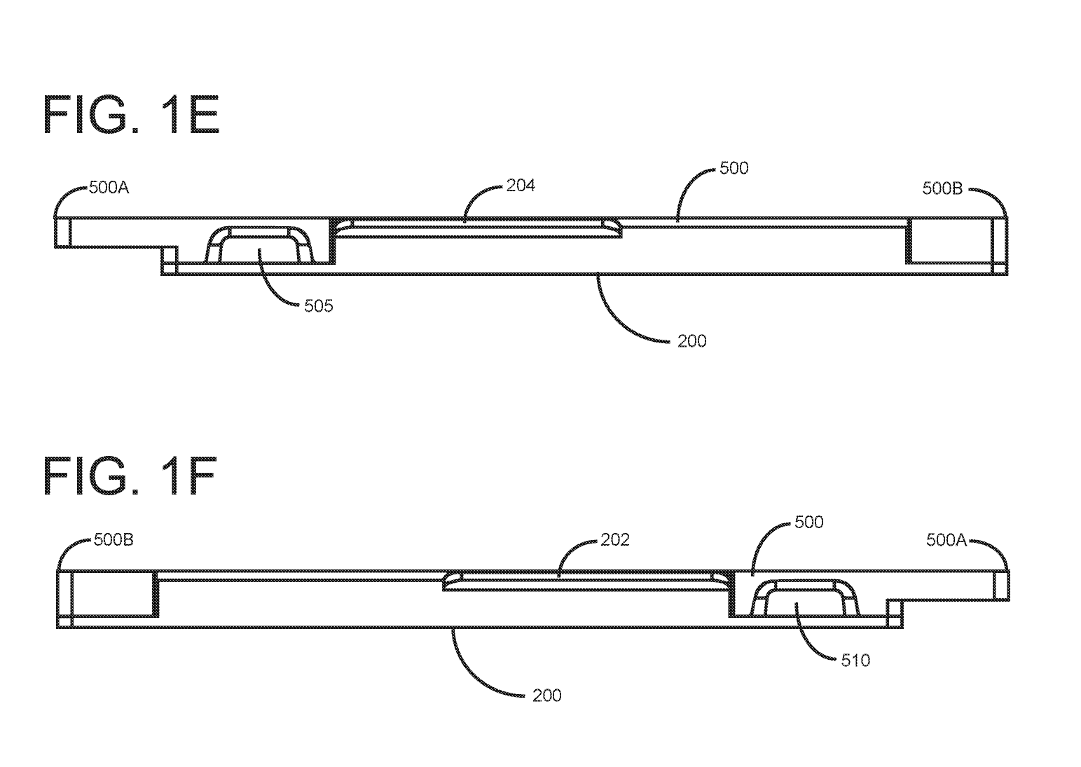

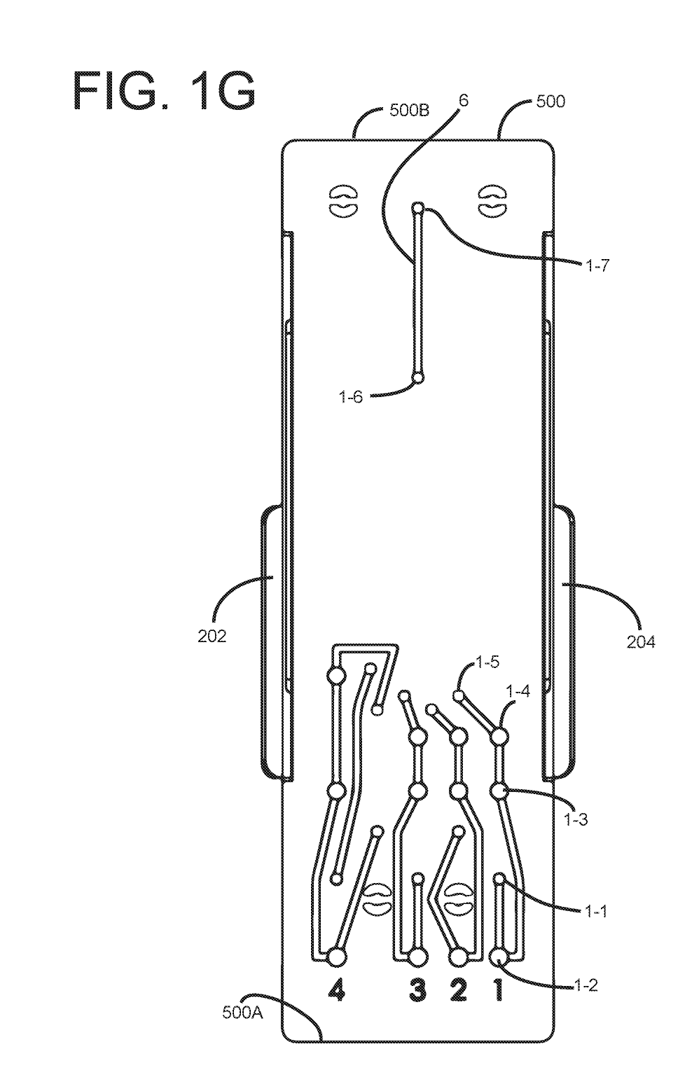

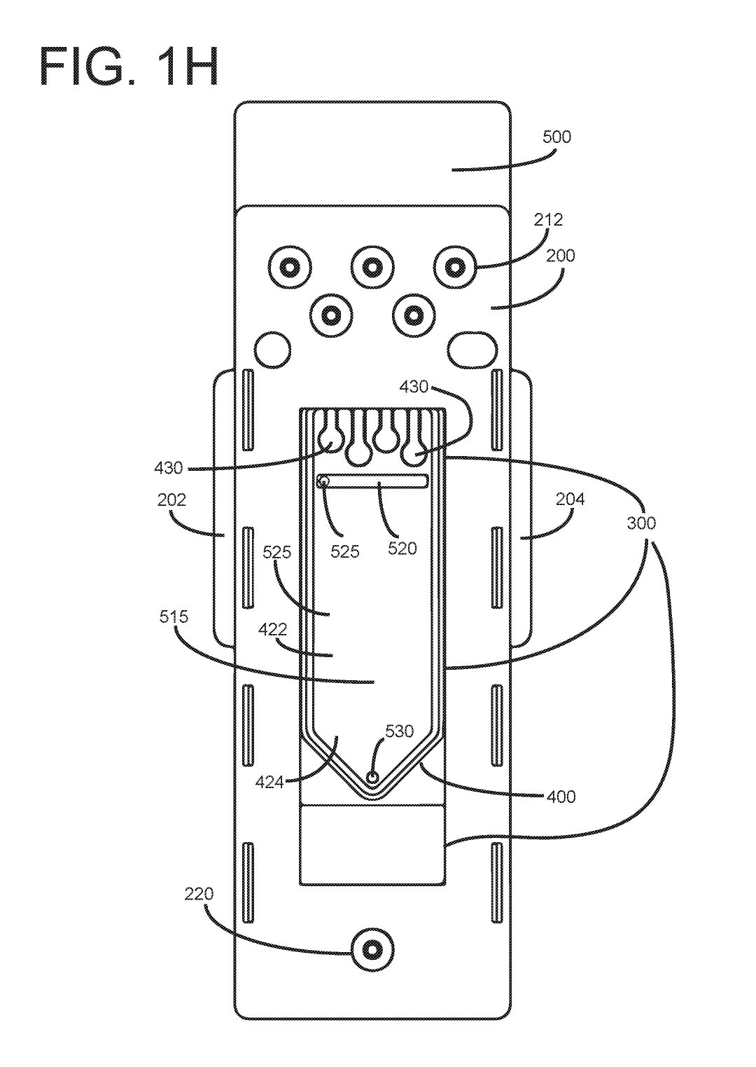

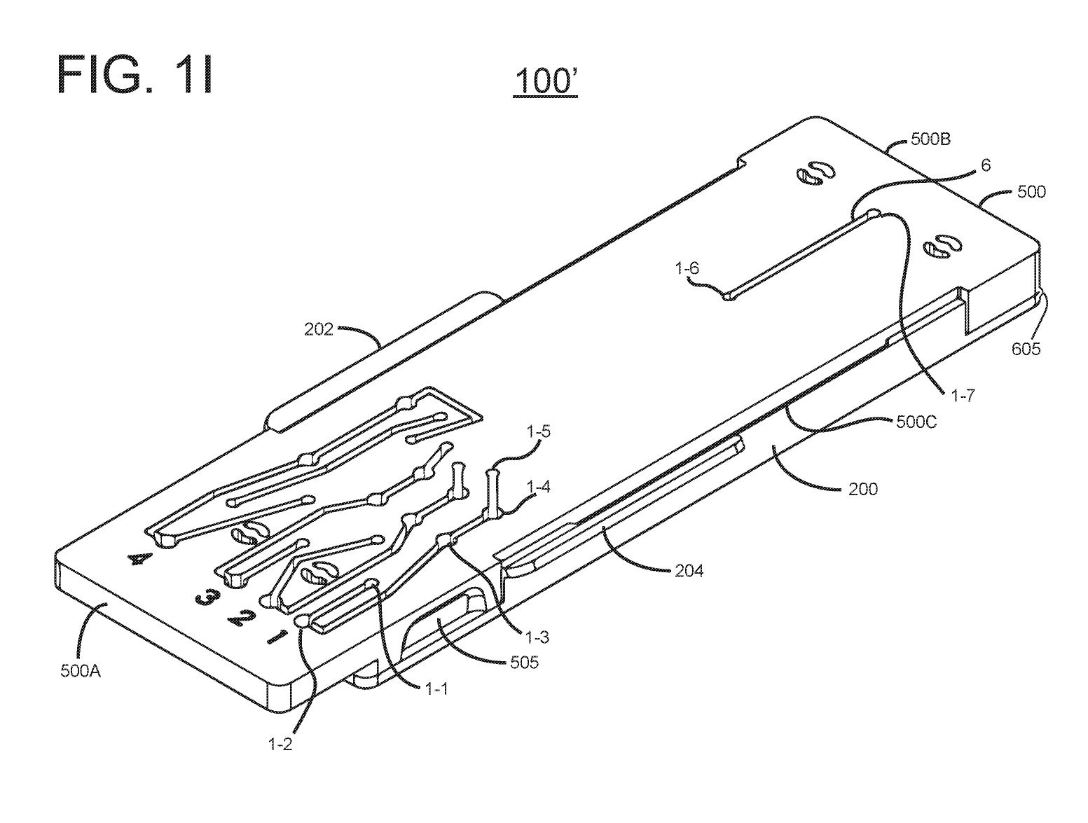

FIG. 1A is an exploded view of one embodiment of the disclosed sample processing receptacle 100. i.e. cartridge 100. Receptacle 100 includes lower member 200, glass slide 300, gasket 400 and upper member 500. Lower member 200 may be fabricated from polycarbonate, polypropylene or other plastic material. Opposed sides of lower member 200 include wing-like tabs 202 and 204 that facilitate the user grasping the receptacle 100 for ease of opening the receptacle. Lower member 200 includes an aperture, i.e. an open region, 206 adjacent a recessed retaining ledge 208. Recessed retaining ledge 208 acts as a receiver that receives and retains glass slide 300 and its sample, i.e. specimen, when the user places glass slide 300 in lower member 200. Glass slide 300 forms one of the sides of the receptacle chamber that is discussed below.

Lower member 200 includes fluid inputs 211, 212, 213, 214 and 215 to which different fluids such as chemical reagents may be supplied when receptacle 100 is fully assembled with glass slide 300 therein. Lower member 200 also includes a fluid output 220 through which all fluids from the chamber within receptacle 100 exit when testing such as staining of the sample (not shown) on the slide 300 within the receptacle is complete.

Receptacle 100 includes gasket 400 that may be fabricated from rubber or similar elastomeric material that provides sealing properties. Gasket 400 includes gasket holes 411, 412, 413, 414 and 415 that mate with fluid inputs 211, 212, 213, 214 and 215, respectively, of lower member 200. Gasket 400 further includes an open region 420 that defines the dimensions of chamber 422. Gasket 400 includes five walls 422-1, 422-2, 422-3, 422-4 and 422-5 that provide the vertical dimension of chamber 422 as depicted in FIG. 1A. Glass slide 300 provides the bottom surface of chamber 422 when the receptacle 100 is completely assembled and closed.

The output end 424 of chamber 422 is V-shaped to promote better flow of reagents through chamber 422 toward the output of the receptacle. Gasket 400 includes a plurality of check valves such as valve 430 that seat in the corresponding holes such as hole 1-4 that extend to the lower or interior major surface 500C of upper member 500. The plurality of check valves such as valve 430 prevent or limit the undesired backflow of reagents from chamber 422 back toward the fluid inputs 211-215 of receptacle 100.

Receptacle 100 includes 5 fluid channels designated 1, 2, 3, 4 and 5. It is noted that channel 4 snakes around fluid channel 5 in FIG. 1A. Fluid channel 5 does not include a check valve into the chamber because in one embodiment fluid channel 5 does not contain any receptacle reagent reservoirs. Fluid channel 5 may exclusive supply off-cartridge bulk reagents from tubes/containers plugged into a separate test instrument. It is noted that there could be fewer or more ports and corresponding channels in the receptacle discussed above wherein a particular number of ports and corresponding channels is presented for example purposes only.

Receptacle 100 also includes upper member 500 that exhibits four fluid channels that are formed extending into the major surface 502 thereof. These four fluid channels are input channels that are designated 1, 2, 3 and 4 adjacent input end 500A. Upper member 500 also includes an output fluid channel 6 adjacent output end 500B. The lower or interior major surface 500C of upper member 500 provides the top surface, i.e. roof, of chamber 422 when receptacle 100 is completely assembled and closed. In one embodiment, a sealing layer 530 is situated at major surface 502 to seal the fluid channels, input holes, output holes, and reservoirs thereof within receptacle 100. In FIG. 1A, sealing layer 530 is transparent to allow viewing of the contents of the fluid channels. Sealing layer 530 may be fabricated from a thin layer of clear plastic tape material that adheres to major surface 502. In another embodiment, sealing layer 530 is not transparent and may include a label identifying the reagents packaged in the receptacle and the protocol to be used for that particular receptacle. Sealing layer 530 may also have a barcode label identifying the receptacle reagents, purpose, protocol, and manufacturing information.

A representative fluid flow through a fully assembled closed receptacle 100 containing a sample specimen is now discussed. The fully assembled closed receptacle 100 is placed in one of multiple bays in a test instrument that is discussed in more detail below. While receptacle 100 stores multiple low-volume reagents on board the receptacle itself for a particular test protocol, the test instrument provides higher volume reagents as needed for the particular test. The test instrument acts as a source of higher volume reagents that is external to the receptacle itself. These higher volume reagents may include general reagents and buffers, water, alcohol, and application(s) specific wash reagents and specimen processing reagents. The higher volume reagents are supplied via dedicated reagent port/channel on the receptacle. In actual practice, higher volume reagents pass through reagent fluid channel 4, namely the channel that snakes around channel 5. It is noted that any channel of the receptacle can be configured to flow higher volume reagents.

For example, if a particular test protocol requires a higher volume of reagent, the test instrument provides the required reagent to a representative fluid input 212 of lower member 200. While FIG. 1A is an exploded view of receptacle 100 that shows vertical dashed lines with arrows to indicate fluid flow from the input side to the output side of receptacle 100, it should be understood that before testing commences, receptacle 100 is fully assembled with glass slide 300 therein to form a sandwich-like structure such as depicted in the assembled receptacle 100 of FIG. 1B. Returning to FIG. 1A, the reagent provided to fluid input 212 flows upward through gasket hole 412, as indicated by arrow A. After passing through gasket hole 412, the reagent passes through hole 1-1 of upper member 500, as indicated by arrow B. The reagent continues flowing and flows along channel 1. In actual practice, higher volume reagents pass through reagent fluid channel 4, namely the channel that snakes around channel 5.

Port 1-1 is a port for incoming lyophilized reagent rehydration water/buffer. Protocol specific Lyophilized reagent (antibodies, DNA/RNA oligonucleotides or enzymes) can be located in position 1-2, and/or 1-3, and/or 1-4. In one embodiment, lyophilized reagent can be located in 1-2 and lyophilized “blank” buffer (without reagents antibodies or DNA/RNA or enzyme) “blocking pellet” can be “packed” in 1-3, and/or 1-4. In another embodiment, lyophilized reagent can be located within the channel structure (not in reservoir) between the reservoirs and lyophilized “blank” buffer can be “packed” in 1-2 and/or 1-3 and/or 1-4. The lyophilized “blank” buffer acts as chemically dissolvable valves protecting the lyophilized reagents from chamber back-flow or vapors from within the bay manifold or chamber. Packing of the lyophilized blank buffer makes the channel air tight and traps any vapor or moisture entering the channel thus protecting the lyophilized reagent from premature rehydration or vapor contamination prior to its use. When a channel is opened for flow, the rehydration water or buffer flows through that channel rehydrating the lyophilized “blank” buffer and lyophilized reagent and dispensing into the chamber. Each channel 1-4 can contain a unique lyophilized reagent or same. The normally closed check valves within the chamber sealing 1-4 channels also isolate the channels from the chamber. When rehydration water or buffer flows through the channel, it rehydrates all lyophilized reagents in its path and pushes the check valve open into the chamber. The purpose of check valves and dissolvable channel block is the same as preventing back flow from the chamber into the channel and acting as a vapor barrier to protect the lyophilized reagent located within that channel path/reservoirs. It is possible to have an embodiment where check valves are not designed in and only blocking lyophilized pellet is utilized as check valves to prevent back flow from chamber into a channel.

A representative fluid channel 1 extends between hole 1-1 and hole 1-5, as shown. The reagent fluid flows from hole 1-1 along channel 1, by reservoir 1-2, by reservoir 1-3, by reservoir 1-4, to exit hole 1-5.

After flowing through fluid channel 1, the reagent exits hole 1-5. The reagent flows downward in the direction of gravity and pressure as indicated by arrow C. Prior to fluid flowing through channel 1, check valve 430 is closed, i.e. check valve 430 rests in a corresponding hole such as 1-4 or 1-5 to prevent backflow of fluids in chamber 422 toward the fluid inputs of receptacle 100. It is noted that instead of a check valve being used as valve 430, an umbrella valve may be employed instead. Advantageously, umbrella valves also allow one-way flow of liquid but in comparison to check valves, umbrella valves will close after liquid passes therethrough. Once fluid from fluid input 212 passes through channel 1 and reaches valve 430, valve 430 flexibly opens downward in the direction of gravity under the pressure of fluid flow from the input which is under pressure supplied by a pump in the test instrument described below. The reagent provided to input 212 thus reaches chamber 422 and the sample (not shown) on glass slide 400. After passing through chamber 422, the reagent and other fluids in chamber 422 will pass from V-shaped chamber end 422 up to hole 1-6 as indicated by arrow D. The fluids then travel along liquid channel 6 to hole 1-7. From hole 1-7, the fluids travel through gasket output hole 416 as indicated by arrow E. The fluids then travel from gasket whole 416 to fluid output hole 220 in lower member 220, as indicated by arrow F, at which point the fluids are exhausted from receptacle 100 for collection and proper disposal. Once the fluids are drained from the receptacle, the receptacle may be opened and the user removes the slide removed from the receptacle. The specimen on the slide may then be studied under a microscope. Such viewing under a microscope is post-processing, i.e. post-staining or post treatment by the liquid chemicals that were in chamber 422.

FIG. 1B is a top perspective view of the assembled receptacle 100 with the glass specimen slide 300 installed inside. Like numbers indicate like elements when comparing receptacle 100 of FIG. 1B with receptacle 100 of FIG. 1A. FIG. 1B shows that upper member 500 includes an indentation 505 adjacent wing-like tab 204 of lower member 200. Indentation 505 cooperates with wing-like tab 204 to make it easier for the user to grasp receptacle 100. Upper member 500 also includes another indentation 510 (not shown in this view) adjacent wing-like tab 202 on the opposed side of upper member 500 for the same purpose. In one embodiment, upper member 500 includes a ledge adjacent end 500A that overhangs lower member 200 below.

FIG. 1C is a front side plan view of receptacle 100 including upper member 500 and lower member 200, and showing wing-like table 202 and 204. FIG. 1C is viewed facing upper member end 500A. FIG. 1D is a rear side plan view of receptacle 500 including upper member 500 and lower member 200, and showing wing-like table 202 and 204. FIG. 1D is viewed facing upper member end 500B.

FIG. 1E is a right side plan view of receptacle 500 including upper member 500 and lower member 200, and showing wing-like tab 204. FIG. 1E is viewed facing tab 204 FIG. 1F is a left side plan view of receptacle 500 including upper member 500 and lower member 200, and showing wing-like tab 202. FIG. 1F is viewed facing tab 202.

FIG. 1G is a top plan view of receptacle 100 showing the upper member 500 of receptacle 100. When comparing the view of FIG. 1G with receptacle 100 of FIG. 1B, like numbers indicate like elements.

FIG. 1H shows a bottom plan view of receptacle 100. The view of FIG. 1H shows upper member 500, lower member 200, multiple fluid inputs such as fluid input 212. Upper member 500 includes a roof 515 with a fluid channel 520 therein. Fluid channel 520 includes a channel opening 525 that fluidically couples to one of the remaining fluid inputs of upper member 500 other than fluidic input 212. In this way a fluid such as a reagent or water is supplied to chamber 422 in a quantity and/or concentration appropriate four a particular test protocol. Chamber output end 424 is V-shaped and corresponds to the V-shape of the gasket 400 end adjacent an output hole 530 in roof 515 of upper member 500. Output hole 530 fluidically couples to fluid output 220 of lower member 200 via fluid channel 6 which is visible in FIG. 1B.

FIG. 1I is a perspective view of an alternative embodiment receptacle, namely receptacle 100′ that is configured similarly to receptacle 100 of FIG. 1B, except that receptacle 100′ includes a hinge 605 that connects upper member 500 to lower member 200 at the output end of the receptacle. In one embodiment, hinge 605 is a living hinge that is integrally formed of the same polycarbonate, plastic, or similar material that forms upper member 500 and lower member 200.

In one embodiment, receptacle 100 may include multiple interior alignment pins and corresponding holes that assist in aligning, mating and closing upper member 502 to lower member 200.

It is noted that an onboard lyophilized reagent is a reagent that is onboard a receptacle prior to being placed in a receptacle.

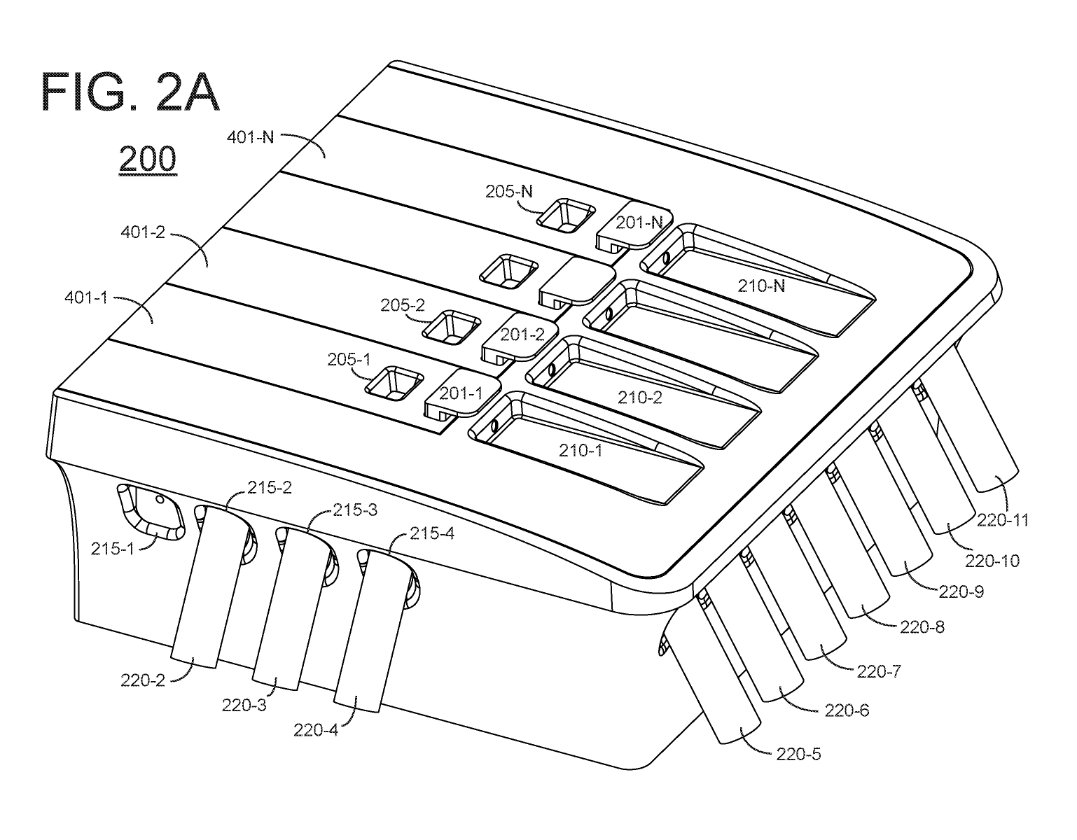

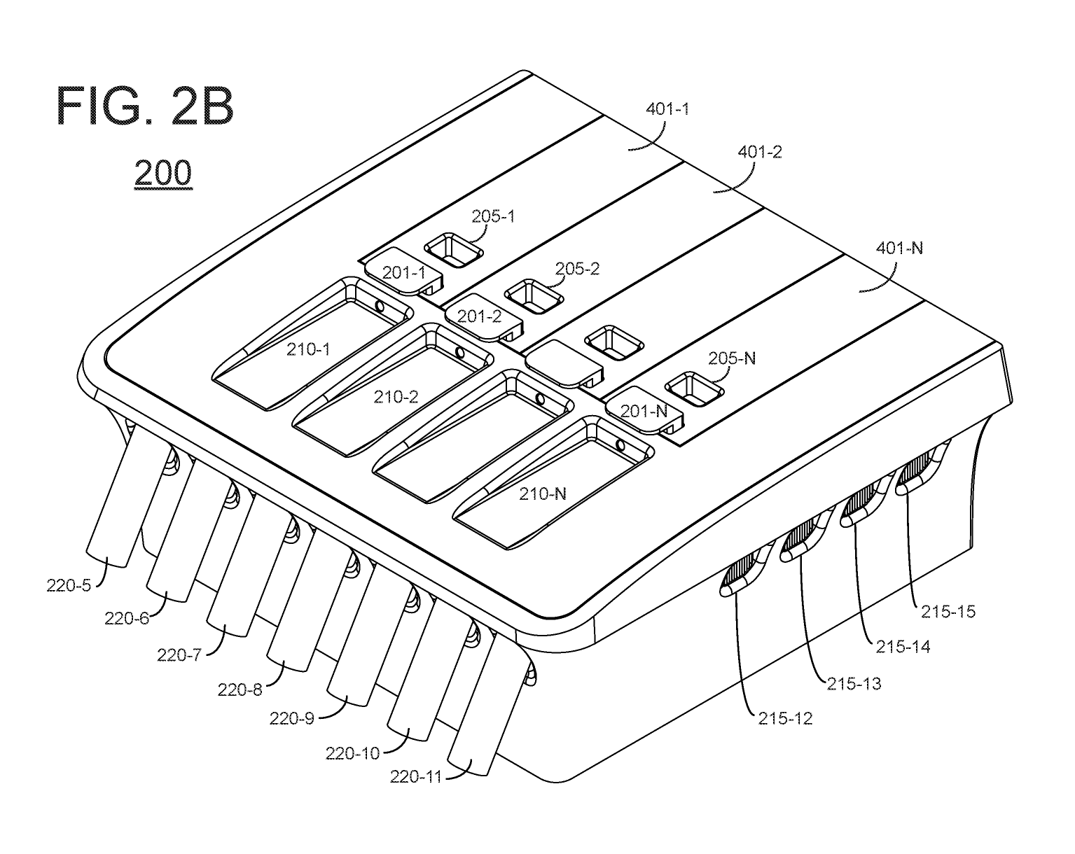

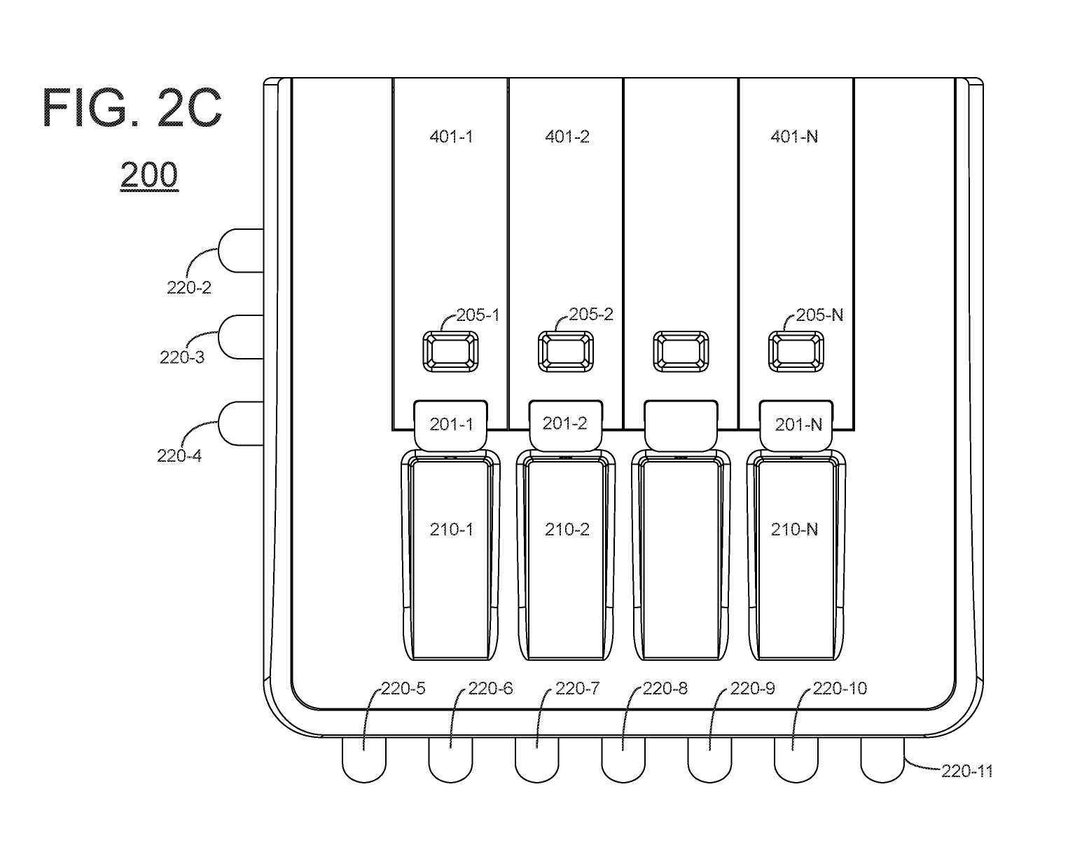

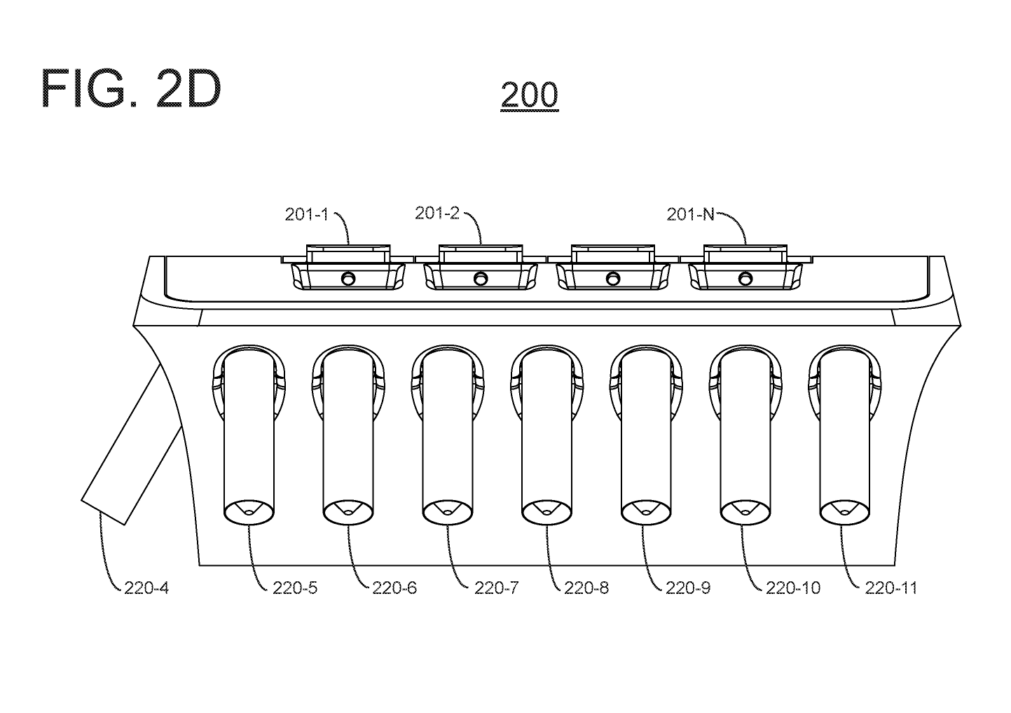

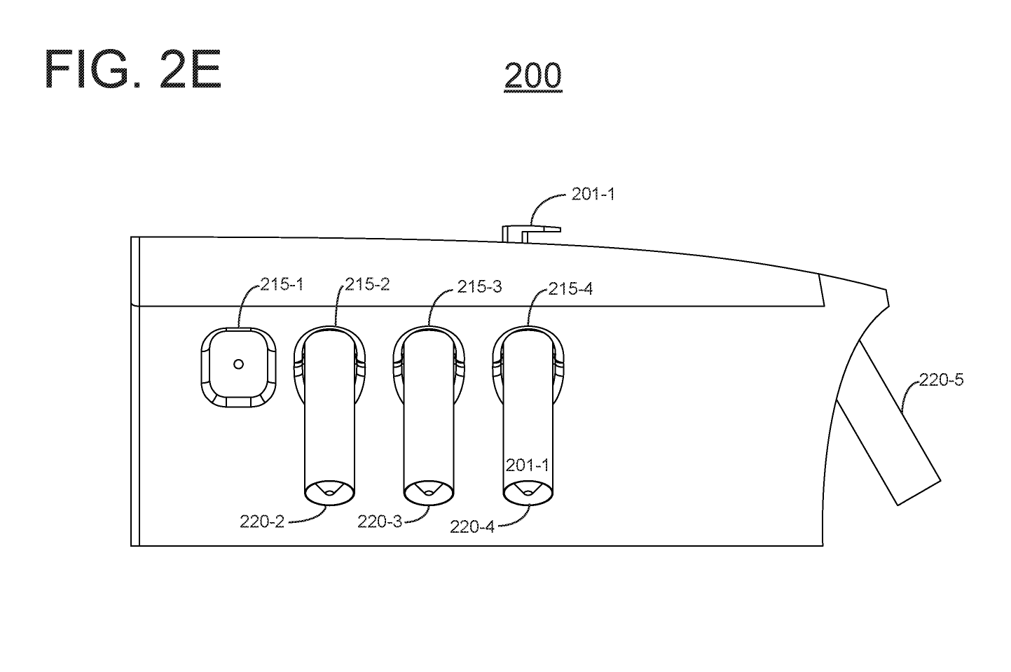

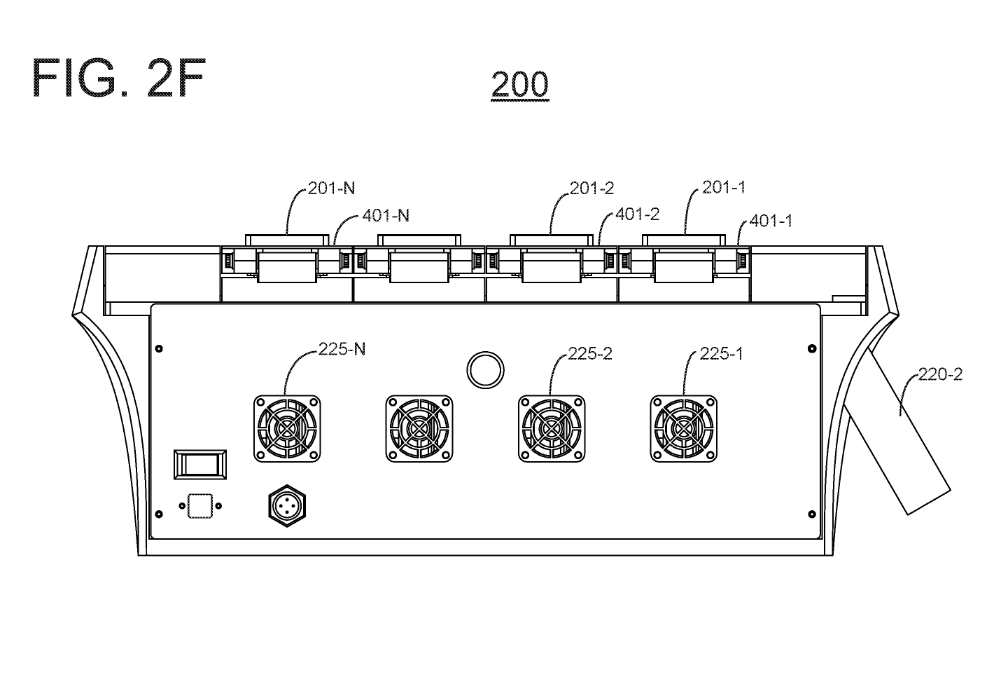

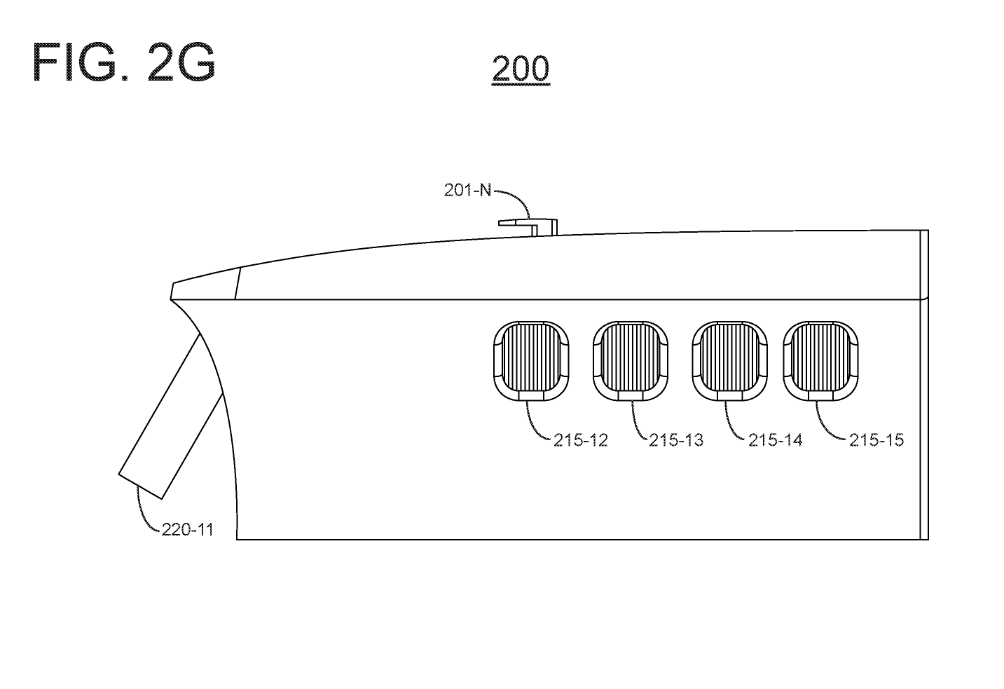

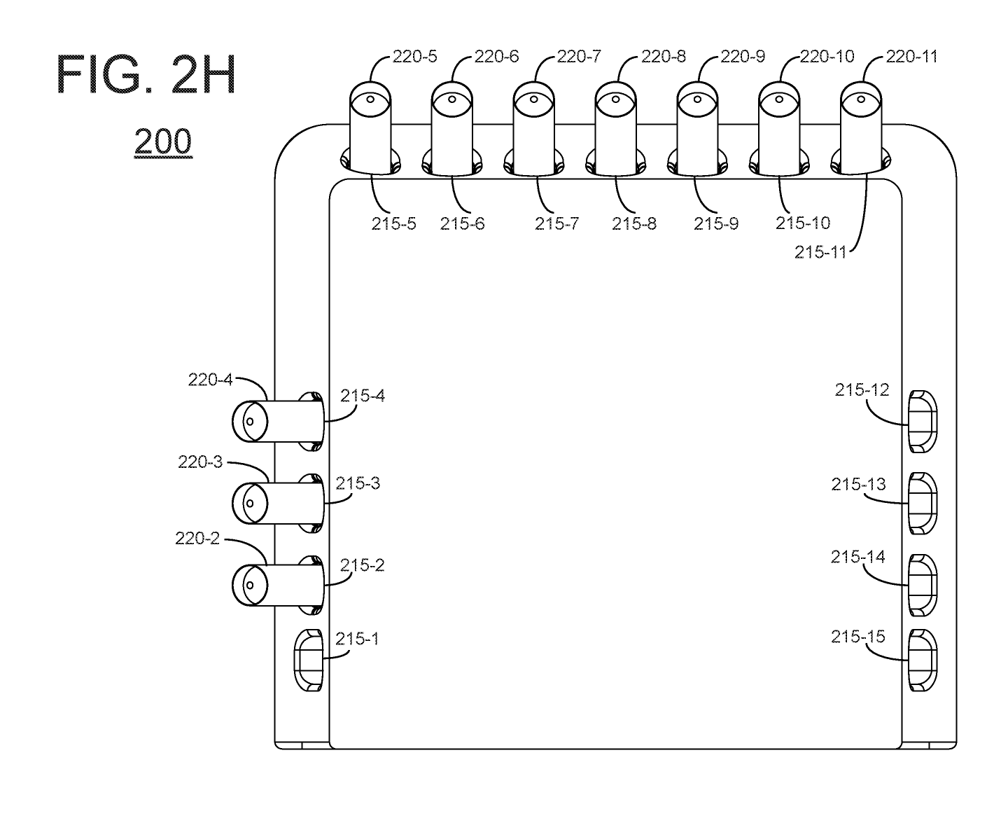

An apparatus that processes specimen receptacles in parallel is also disclosed. FIGS. 2A-2H show several different views of the specimen processing apparatus, i.e. test instrument. The sample processing apparatus is useful with self-contained specimen slide processing receptacles, i.e. cartridges. These receptacles receive specimens, reagents and other fluids.

FIG. 2A is a top left side perspective view of one embodiment of the disclosed specimen processing apparatus 200, i.e. instrument 200. Instrument 200 includes receptacle receiving bays 401-1, 401-2, . . . 401-N, wherein N is the total number of bays in instrument 200. Each of bays 401-1, 401-2 . . . 401-N includes a respective handle 201-1, 201-2, . . . 201-N to facilitate the user opening a bay prior to placing a receptacle including a sample in the bay. Each of bays 401-1, 401-2 . . . 401-N includes a respective viewing port 205-1, 205-2, . . . 205-N through which the user may look to see if a receptacle is present within the respective bay. Instrument 200 includes recesses 210-1, 210-2, . . . 210-N in the top thereof. Each recess provides a location to place a receptacle (such as receptacle 100 of FIG. 1B) containing a specimen prior to opening a respective bay to insert the receptacle in the bay for specimen testing. Each recess 210-1, 210-2, . . . 210-N is associated with a respective receptacle bay 401-1, 410-2, . . . 412-N.

In this particular embodiment, the left side of instrument 200 includes ports 215-1, 215-2, . . . 215-4 that may receive respective tubes 220 therein. More particularly, in this particular example, while port 215-1 is open, ports 215-2, 215-3 and 215-4 are populated with respective tubes 220-2, 220-3 and 220-4. These tubes are vessels that store bulk reagents or small reagents therein. Small reagents are reagents in smaller quantities than typically associated with bulk reagents. A small reagent is a small volume reagent exhibiting a smaller volume than a bulk reagent. The front side of instrument 200 includes 7 ports that are populated with respective tubes 220-5, 220-6, . . . 220-11, as shown.

FIG. 2B shows a top right side perspective view of instrument 200. In this particular view, instrument 200 is shown with open ports 215-12, 215-13, 215-14 and 215-15. Instrument 200 receives tubes 220-5, 220-6, . . . 220-11 in respective ports spaced apart along the front of the instrument. These tubes may store either bulk reagents or small reagents therein, depending on the particular specimen testing protocol. Ports 215-12 . . . 215-15 are open without installed tubes in this particular example. FIG. 2C is a top plan view of instrument 200. FIG. 2D is a front plan view of instrument 200. FIG. 2E is a left side plan view of instrument 200. FIG. 2F is a back side plan view of instrument 200 showing cooling fans 225-1, 225-2, . . . 225-N located on the back side. Each of these fans is dedicated to cooling and heat removal from a respective receptacle bay.

FIG. 2G is a right side plan view of instrument 200 showing open ports 215-12, 215-13, . . . 215-15 with no reagent tubes currently installed therein. Bulk and small volume reagents can be used interchangeably in any port position (i.e. tube position). An open port may be used to connect another tube than can supply reagent/water to rehydrate pellets/lyophilized reagents stored in the receptacle that can be procedure specific for that specimen. One reagent can be a specific probe (DNA or antibody probe) for a specific marker on the specimen, and, other pellet reagents may alternatively not be specimen specific.

FIG. 2H is a bottom plan view of instrument 200 showing reagent tubes 220-2, 220-3, . . . 220-11 installed in respective ports 215-2, 215-3, . . . 215-11. Instrument 200 is configured internally such that such reagent tubes are common to each of the receptacle bays. In this manner, instrument 200 may supply a particular reagent from a particular reagent tube to multiple receptacle bays simultaneously. In other words, in one embodiment, each of the reagent tubes may supply multiple receptacle bays in parallel to dramatically increase efficiency by enabling the testing of multiple receptacle specimens at the time.

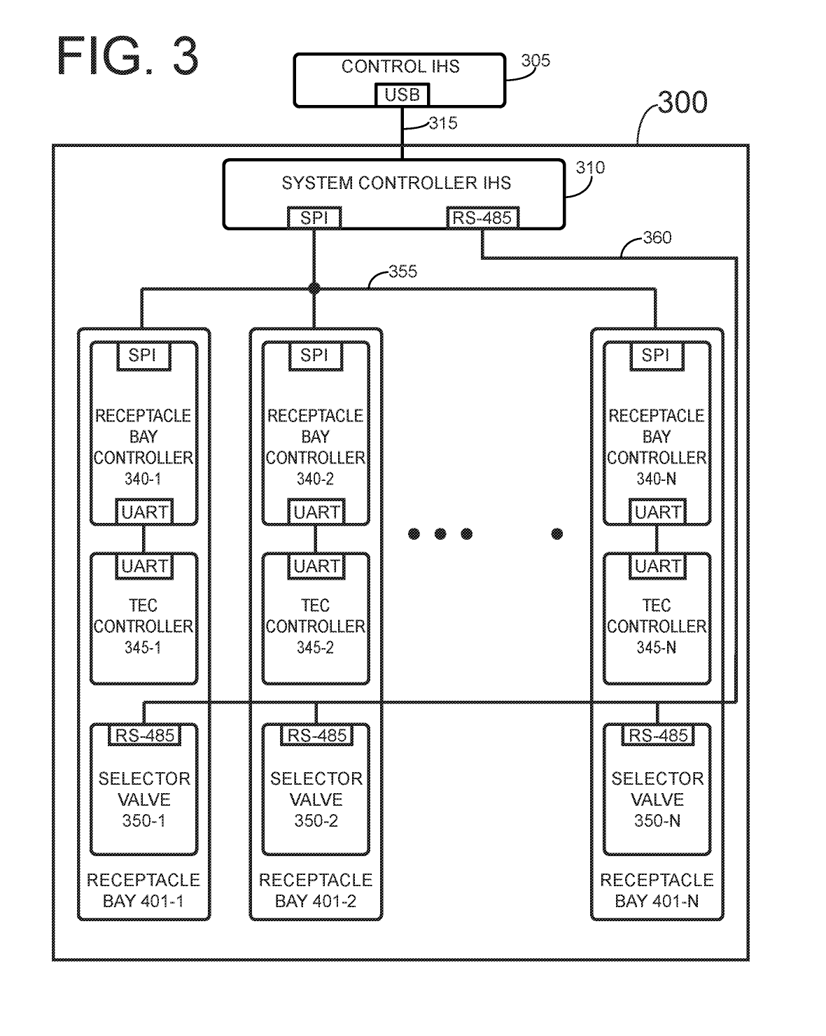

FIG. 3 is a block diagram showing one embodiment of the disclosed specimen processing system that is depicted as instrument 300. Instrument 300 includes the mechanical structures shown in FIGS. 2A-2H as well is the electrical blocks depicted in FIG. 3. Instrument 300 employs a control information handling system (IHS) 305 such as a personal computer, workstation, server, handheld computing device, smartphone or other stationary or portable computing device. Control IHS may be external to instrument 300 as shown. Alternatively, control IHS may be incorporated within instrument 300. Control IHS may be used to input testing parameters and other test-related information to instrument 300.

Instrument 300 includes a system controller information handling system (IHS), namely system controller IHS 310. In one embodiment, system controller IHS 310 is implemented as a microcontroller that is programmable to control reagent distribution to the receptacle bays described below. System controller IHS 310 may communicate with control IHS 305 via a USB communication link 315 or other communication link. Communication link 315 may be wired or wireless. Instrument 300 may also include a plurality of receptacle bays 401-1, 401-2, . . . 401-N, wherein N is the total number of receptacle bays in instrument 300. The receptacle bays may also be referred as cartridge bays because these receptacle bays receive respective cartridges (i.e. receptacles) containing specimens for testing.

In the course of testing, instrument 300 may supply one or more reagents to each receptacle in its respective testing bay. Different tests may be simultaneously conducted in different receptacle bays of instrument 300. For example, a first test may be conducted in a receptacle with specimen placed in receptacle bay 401-1. The first test may require bulk reagent A, bulk reagent B and small reagent C. A second test that is different from the first test and requiring different reagents may be conducted in another receptacle with specimen placed in receptacle bay 401-2. The second test may require bulk reagent B, small reagent C and bulk reagent D. Instrument 300 is configured such that at the same time it supplies bulk reagent A, bulk reagent B and small reagent C to the receptacle within receptacle bay 401, instrument 300 also supplies bulk reagent B, small reagent C and bulk reagent D to the receptacle in receptacle bay 401-2. In this manner, tests 1 and 2 are conducted in parallel. Alternatively, tests 1 and 2 may be conducted sequentially if desired by the user. Instrument 300 may also supply receptacles in the remaining receptacle bays with other reagents simultaneously in parallel with the supply of the above described reagents to receptacle bays 401-1 and 401-2.

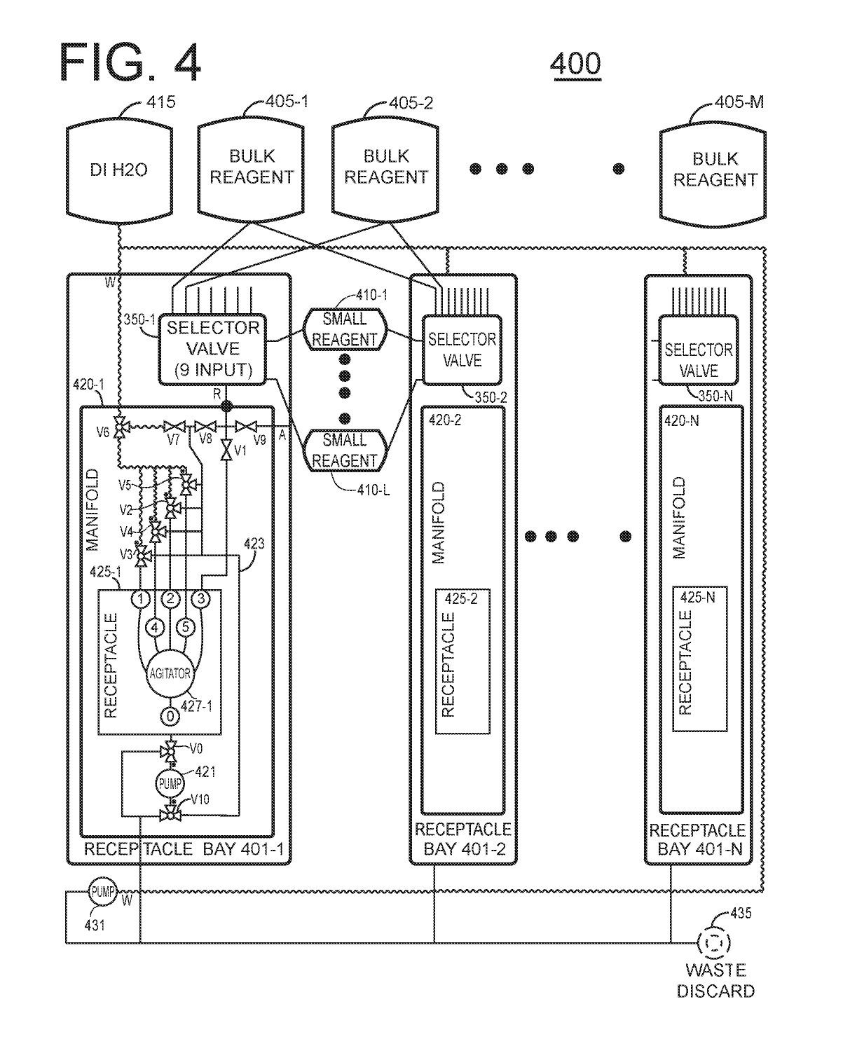

In the above-described testing, a tube holding bulk reagent B (e.g. tube 220-3 of FIG. 2A) acts as a common reagent store with respect to the first test that instrument 300 conducts in receptacle bay 401-1 and the second test that instrument 300 conducts in receptacle bay 401-2. Likewise, a tube holding small reagent C (e.g. tube 220-4 of FIG. 2A) acts as a common reagent store with respect to the first test that instrument 300 conducts in receptacle bay 401-1 and the second test that instrument 300 conducts in receptacle bay 401-2. Reagents from each of these tubes may flow to their respective coupled receptacle bays at the same time in parallel. Valve operations, that are described in more detail with respect to FIG. 4 below, control these parallel reagent flows.

It is noted that in the current generation of conventional instruments where reagents are dispensed using one or more robotic liquid dispensing arms, this conventional arrangement would hinder an attempt to parallel process or supply same reagents to multiple specimen slides simultaneously. In contrast, the disclosed parallel processing features allow each bay and receptacle to be independently processed including the removal and addition of a new slide specimen in a receptacle safely without affecting, pausing or stopping the procedure for other receptacles. This feature lends itself to significantly higher throughput with a smaller footprint of the instrument relative to a robotic or rotating carousel-based liquid dispensing instruments that share resources for liquid dispensed when processing more than one specimen.

System controller IHS 310 may communicate with receptacle bays 401-1, 401-2, . . . 401-N via communication link 355. Communication link 355 may be a wired or wireless communication link. In one embodiment, communication link 355 may utilize serial peripheral interface (SPI) communications to couple system controller IHS 310 with receptacle bays 401-1, 401-2, . . . 401-N. The block diagram of FIG. 3 employs a convention wherein signal lines that cross one another are not connected to one another unless a connection is indicated by a circle at the point of connection.

Each receptacle bay 401-1, 401-2, . . . 401-N may include a respective receptacle bay controller 340, thermal electric cooler (TEC) controller 345, selector valve 350 (also shown in FIG. 4), and a pump such as pump 421 (shown in FIG. 4). Taking receptacle bay 401-1 as being representative of the receptacles bays, system controller IHS 310 communicates with receptacle bay 401-1 via the SPI bus 355. Receptacle bay controller 340-1 thus receives commands from system controller IHS 310 via SPI bus 355. Receptacle bay controller 340-1 communicates via its UART (universal asynchronous receiver-transmitter) to a corresponding UART in TEC controller 345-1. In this manner, receptacle bay controller 340 instructs TEC controller 345-1 with respect to the particular temperature it should heat or cool the specimen and contents of the chamber of the receptacle in receptacle bay 401-1 for the particular test currently being conducted on the specimen in that receptacle. In one embodiment, the TEC makes direct contact with the slide only of the receptacle. Receptacle bay controller 340 controls other functions such as opening and closing rotary valves, valves on inlet and outlet ports, turning a pump on, turning a pump off, reversing direction of the pump, electromagnetic coil turning on/off, switching polarity, LED indicators on/off and switching colors of an LED based on particular function being represented, reading barcode/RFID on receptacle/slide if present.

Prior to running the test, a user or other entity may input control parameters, such as the temperature desired for a particular test, into control IHS 305. Control IHS 305 transmits these control parameters to system controller IHS 310. In the case of a temperature control parameter, system controller 310 instructs receptacle bay controller 340-1 with respect to the particular temperature needed for a test in receptacle bay 401-1. In response to receiving this temperature control parameter, receptacle bay controller 340 instructs TEC controller 345-1 with respect to the particular temperature to heat or cool receptacle bay 401-1 for the particular test in that receptacle bay.

Continuing with the discussion of a representative specimen test in a receptacle in receptacle bay 401-1, system controller IHS 310 instructs multiple input selector valve 350-1 with the respect to the particular input to select to receive a particular reagent from a particular reagent store. As discussed in more detail below with reference to FIG. 4, each input of multiple input selector valve 350-1 couples to a respective bulk reagent store or a respective small reagent store. In one embodiment, system controller IHS 310 employs a low noise RS-485 communication bus 360 to communicate valve input selection information to selector valves 350-1, 350-2, . . . 350-N.

FIG. 4 is a block diagram showing one embodiment of the disclosed of instrument described above but now referenced as instrument 400. Instrument 400 includes the mechanical elements described above as instrument 200 in FIG. 2A-2I and the electrical components described above as instrument 300 in FIG. 3. Instrument 400 may include a plurality of bulk reagent reservoirs 405 designated as bulk reagent stores 405-1, 405-2, . . . 405-M, wherein M is the total number of bulk reagent stores, (i.e. bulk reagent reservoirs). Specimen processing apparatus 400 also may include a plurality of small reagent stores 410-1, . . . 410-L, wherein L is the total number of small reagent stores. The small reagent stores are low volume reagent stores as compared to the volume of the bulk reagent stores that are high volume reagent stores. Instrument 400 may also include a deionized (DI) water (H20) store 415. Alternatively, store 415 may store another reagent. In FIG. 4, fluid lines carrying water are drawn as rippled lines and/or are designated “W” for water to distinguish them from other fluid lines. In one embodiment, instrument 400 may include receptacle bays 401-1, 401-2, . . . 401-N, wherein N is the total number of receptacle bays. Each receptacle bay may operate independently of the other receptacle bays under the control of system controller IHS 310 to supply the receptacle bays with appropriate reagents and water according to the different tests being conducted in each receptacle bay.

Receptacle bays 401-1, 402-2, . . . . 402-N each include a respective multi-input selector valve 350-1, 350-2, . . . 350-N. The operation of receptacle bay 401-1 is now discussed as being representative of the operation of the other receptacle bays, keeping in mind that each receptacle bay may conduct independent testing with different combinations of reagents being supplied thereto. Receptacle bay 401-1 includes a 9-input selector valve 350-1 in this particular embodiment. Those skilled in the art will appreciate that receptacle bay 401-1 may employ a number of inputs less than or greater than 9. In one embodiment, multi-input selector valve 350-1 includes one input for each reagent store that instrument 400 employs. If instrument 400 includes 7 large reagent stores 405 (i.e. M=7) and further includes 2 small reagent stores 410 (i.e. L=2), then instrument 400 includes a total of 9 reagent stores. In this case, selector valve 350-1 includes 9 inputs, one input being dedicated to each reagent store, as shown in FIG. 4.

Receptacle bay 401-1 further includes a manifold 420-1 on which receptacle 425-1 is situated. In actual practice, referring momentarily back to FIG. 2A, to place receptacle 425-1 in receptacle bay 401-1 the user pulls handle 201-1 upward so that the top of bay 401-1 pivots upward about a hinge (not shown) to the rear of receptacle bay 401-1. This opens up receptacle bay 401-1 to expose the manifold 420-1 on which the user places the receptacle 425-1 as shown in FIG. 4. The interior of receptacle bay 401-1 is geometrically shaped to accommodate the shape of receptacle 425-1 when the open top of the receptacle bay is closed by the user pushing down handle 201-1 until the top of bay 401-1 returns to the closed position depicted in FIG. 2A. A thermoelectric cooler (TEC, not shown) floats on springs (not shown) in a cut out in the middle of manifold 420-1 so that system controller IHS 310 and receptacle bay controller 340-1 and TEC controller 345-1 may heat or cool the slide and contents of receptacle 425-1 to a particular temperature provided as an input parameter by the user for the particular testing protocol desired at this receptacle bay. The TEC makes contact with the slide of the receptacle to enable the TEC to heat or cool the slide and its contents to the prescribed temperature. In one embodiment, the TEC does not heat or cool manifold 420-1, but rather heats or cools just the slide and the contents inside the chamber of the receptacle. The TEC does not have sufficient heating or cooling capability to heat or cool the large thermal mass of manifold 420-1 which is metallic. For this reason, in one embodiment the receptacle is made of material that can effectively thermally isolate the slide and its contents from manifold 420-1 and the rest of the instrument.

In one embodiment, bulk reagent store 405-1 couples to one input of each of selector valves 350-1, 350-2, . . . 350-N. Likewise, bulk reagent store 405-2 couples to one input of each of selector valves 350-1, 350-2, . . . 350-N. Similarly, bulk reagent store 405-M couples to one input of each of selector valves 350-1, 350-2, . . . 350-N (connection not shown due to space limitations). In this manner, bulk reagent store 405-1 is common to all receptacle bays, bulk reagent store 405-2 is common to all receptacle bays, and bulk reagent store 405—is common to all receptacle bays. Small reagent stores 410-1 . . . 401-L couple to respective inputs of each of selector valves 350-1, 350-2, . . . 350-N such that these small reagent stores are common to all receptacle bays. In summary, receptacles 425-1, 425-2, . . . 425-N may acquire access to the same common bulk reagent stores in parallel under the control of system controller IHS 310. Likewise, receptacles 425-1, 425-2, . . . 425-N may acquire access to the same common small reagent stores in parallel under the control of system controller IHS 310. The diagram of FIG. 4 employs a convention wherein fluid lines that cross one another are not connected to one another unless a connection is indicated by a circle at the point of connection.

Valves V0, V1, V2, . . . V10 are all situated on manifold 420-1 and are configured as shown in FIG. 4 in one embodiment. Receptacle 425-1 includes fluid input ports 1, 2, 3, 4 and 5 that sit on top of and fluidically couple to respective fluid output ports on manifold 420-1 immediately below fluid input ports 1, 2, 3, 4 and 5 of receptacle 425-1. The 5 fluid output ports of manifold 420-1 are obscured by receptacle 425-1 above these 5 fluid output ports. The 5 fluid output ports of manifold 420-1 couple to, and supply fluid to, fluid input ports 1, 2, 3, 4 and 5, respectively, of receptacle 425-1. Manifold 420-1 also includes a fluid input port that couples to fluid output port 0 of receptacle 425-1. Fluid exiting receptacle 425-1 travels from fluid output 0 of receptacle 425-1 to a respective input port of manifold 420-1 immediately below fluid output port 0. Again, receptacle 425-1 obscures the manifold input port immediately below receptacle output port 0 from view.

Input port 3 of receptacle 425-1 is dedicated to receiving one or more reagents selected by selector valve 350-1 one at a time from the reagent stores connected to selector valve 350-1. The output of selector valve 350-1 is labelled “R” to indicate “reagent”. Valve V1 supplies the selected reagent from reagent output R to the dedicated reagent input port 3 of receptacle 425-1. Under the direction of receptacle bay controller 340-1, valves V0-V10 are configured to provide deionized H2O, or alternatively a reagent, in store 415 to receptacle input ports 1, 2, 4 and 5. Valve V9 couples to an air input, A, of receptacle bay 401-1 to provide air to the system as needed. Pump 421 pulls reagents and water through the ports of receptacle 425-1 via valves V1, V10 and V3. Pump 431 pulls water through the instrument 400 so that receptacle bays 401-1, 401-2, . . . 401-N are supplied with water. A waste discard outlet 435 couples to pump 431 to exhaust waste liquid from instrument 400.

Pump 431 is optional, but may be used to assist in directly bypassing manifold 420-1 to prime reagents and water if applicable. Each receptacle manifold, such as manifold 420-1, may also be individually primed by all reagents using the bypass line 423 and pump 421 employed by manifold 420-1, in the absence or presence of a receptacle 425-1 on the manifold 420-1. The bypass line 423 is denoted in FIG. 4 by the line drawn connecting valve V10 to valve V7 In one embodiment, receptacle 425-1 may include a magnet or electromagnet 427-1 that interacts with an electromagnetic coil of receptacle 425-1 to agitate or effectively stir the liquid in the specimen-containing chamber formed within receptacle 425-1.

In one embodiment, for liquid to flow through receptacle 425-1, a specimen slide must be present within receptacle 425-1. For liquid to flow through receptacle 425-1, a specimen slide must be present in receptacle 425-1. The presence of the specimen slide in receptacle 425-1 effectively forms a wall that completes the sealed specimen chamber within receptacle 425-1. This arrangement acts as a type of failsafe mechanism because if the user forgets to place a specimen slide in receptacle 425-1, then receptacle bay controller 340-1 senses the absence of the specimen slide and prompts the user to check the slide in that receptacle.

To provide receptacle 425-1 in receptacle bay 401-1 with a particular bulk reagent that bulk reagent store 405 houses, system controller IHS 310 sends a command to selector valve 350-1 that instructs selector valve 350-1 to select bulk reagent store 405-1 as an input. At the same time, system controller IHS 310 may send a command to selector valve 350-2 of receptacle bay 401-2 to select the same reagent store 405-1 as its input. In this manner, both receptacles 425-1 and 425-2 will receive the same bulk reagent from bulk reagent store 405-1 in parallel, i.e. at the same time. Bulk reagent stores 405-1, 405-2 as well as the other bulk reagent stores are common to receptacle bays 401-1, 401-2, . . . 401-N, in one embodiment. In a similar manner small reagent stores 410-1, . . . 410-L are common to to receptacle bays 401-1, 401-2, . . . 401-N, in one embodiment.

As discussed above, to provide receptacle 425-1 in receptacle bay 401-1 with a particular bulk reagent that bulk reagent store 405 houses, system controller IHS 310 sends a command to selector valve 350-1 that instructs selector valve 350-1 to select bulk reagent store 405-1 as an input. System controller IHS 310 also instructs receptacle bay controller 340-1 to instruct valve V1 to open to allow the flow of the selected bulk reagent from bulk reagent store 405-1 to flow from reagent output R of selector valve 350-1 to the dedicated reagent port 3 of receptacle 425-1. In this manner, receptacle 425-1 receives the selected bulk reagent. System controller IHS 310 also instructs receptacle bay controller 340-1 to open and close valves V6, V2, V3, V4 and V5 as needed to supply water/reagent from water store 415 to receptacle 425. While FIG. 4 shows valve V6 as a three-way valve, it is also possible to implement valve V6 as three two-way valves. In this particular embodiment, valves V2, V3, V4, and V5 are three-way valves. Valves V0 and V10 are likewise three-way valves. Valves V1, V7, V8 and V9 are two-way valves. In another embodiment, each three-way valve can be replaced with a set of 2 two-way valves.

Recirculation of liquids through receptacle 425 is provided by the following circulation paths for each:

Recirculation loop V9-V10-reverse Pump 421-V0-V1-V9

Alternate loops V5-V7-V10-reverse Pump 421-V0-V5

Alternate loops V4-V7-V10-reverse Pump 421-V0-V4

Alternate loops V3-V7-V10-reverse Pump 421-V0-V3

Alternate loops V2-V7-V10-reverse Pump 421-V0-V2

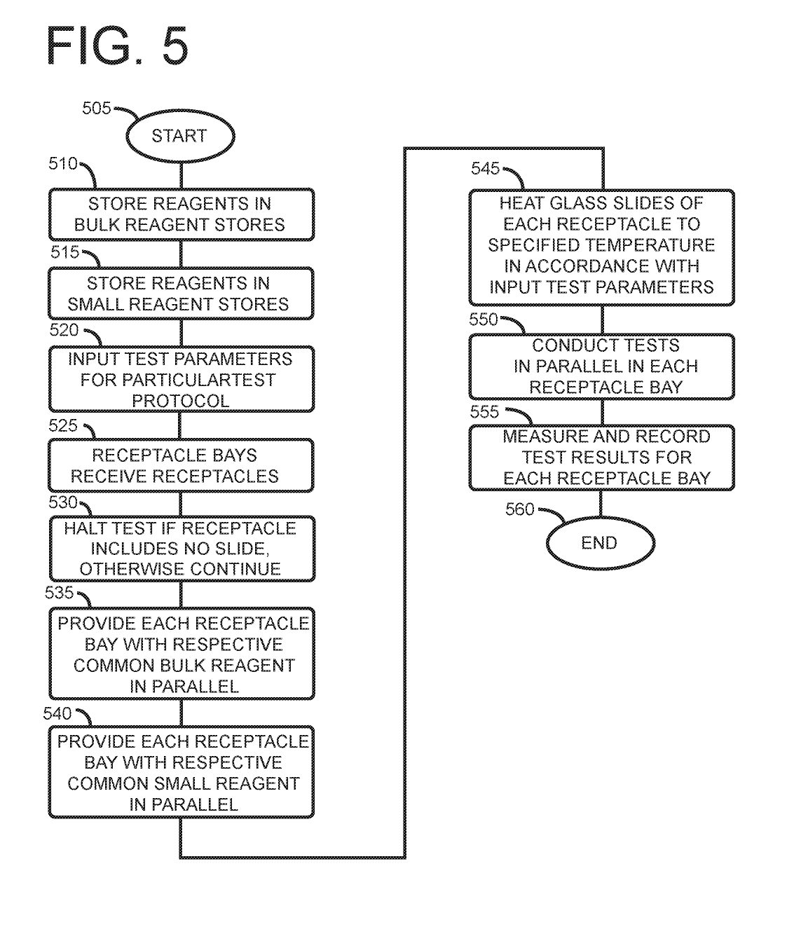

FIG. 5 is a high level flowchart that depicts a representative process flow for conducting testing in accordance with the disclosed testing methodology. Process flow commences at start block 505. A user or other entity stores bulk reagents in bulk reagent stores, as per block 510. A user or other entity stores small reagents in small reagent stores, as per block 515. The bulk reagent stores are common stores accessible by each receptacle bay of the test instrument. The small reagent stores are common stores accessible by each receptacle bay of the test instrument.

A user or other entity inputs test parameters for a particular test into the control IHS of the instrument, as per block 520. Different test parameters and protocols may be specified for each receptacle bay and the receptacle that such bay will receive. The receptacle bays receive respective receptacles therein, as per block 525. Each receptacle bay is now populated with a different receptacle on which a different test is to be conducted. The instrument tests to determine if any receptacle does not include a respective glass slide, as per block 530. The test instrument halts the test for a particular receptacle bay if the receptacle therein does not include a glass slide. Otherwise, the instrument continues testing. Each receptacle bay is provided with access to a common bulk reagent in parallel, as per block 535. Each receptacle bay is provided with access to a common small reagent in parallel, as per block 540.

A respective TEC dedicated to each respective receptacle bay heats or cools the glass slide of the receptacle in each bay to a temperature prescribed for the receptacle in accordance with the input test parameters, as per block 545. The prescribed tests are conducted in parallel on the receptacles in the receptacle bays, as per block 550. Test measurements are taken and test results are recorded for each receptacle bay, as per block 555. Process flow stops at end block 560, or alternatively flows back to start block 505 where the test process starts anew.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A specimen processing apparatus, comprising:
a plurality of receptacle bays each capable of receiving a respective receptacle that includes a specimen slide; and
a plurality of common reagent stores accessible by each of the receptacle bays to supply reagents to the receptacle bays in parallel.

2. The specimen processing apparatus of claim 1, wherein each receptacle includes at least one onboard lyophilized reagent.

3. The specimen processing apparatus of claim 1, wherein each receptacle includes protocol specific reagents that are specific to a protocol of each slide.

4. The specimen processing apparatus of claim 1, wherein the plurality of common reagent stores are configured to supply reagents to the plurality of receptacle bays in parallel.

5. The specimen processing apparatus of claim 1, further comprising:
a plurality of multiple input valves, each multiple input valve being dedicated to a respective receptacle bay, each input of a particular multiple input valve being capable of selecting a different common reagent store.

6. The specimen processing apparatus of claim 1, wherein the specimen slide completes a portion of the receptacle to form a chamber within the receptacle that stores the specimen.

7. The specimen processing apparatus of claim 1, wherein the plurality of common reagent stores includes at least one bulk reagent store.

8. The specimen processing apparatus of claim 1, wherein the plurality of receptacle bays includes first and second receptacle bays that are configured to receive a reagent from a common reagent store at the same time.

9. The specimen processing apparatus of claim 1, wherein each receptacle bay includes a manifold that receives a respective receptacle with specimen, wherein the manifold is fluidically coupled to a reagent port to supply a reagent to the respective receptacle.

10. The specimen processing apparatus of claim 9, wherein the manifold of each receptacle bay is fluidically coupled to a plurality of lyophilized reagent rehydration reagent or water lines to supply rehydration reagent or water to the respective receptacle of each respective receptacle bay.

11. The specimen processing apparatus of claim 1, wherein each receptacle bay includes a respective thermo-electric cooler device to control the temperature of the specimen in the receptacle in the receptacle bay.

12. The specimen processing apparatus of claim 1, wherein a particular receptacle includes at least one reagent in lyophilized form.

13. A method of testing a specimen, comprising:
storing reagents in a plurality of common reagent stores, wherein the common reagent stores are accessible by each of multiple receptacle bays in parallel; and
receiving, by the plurality of receptacle bays, a respective receptacle in each receptacle bay of the plurality of receptacle bays, each receptacle including a specimen slide,

14. The method of claim 13, wherein each receptacle includes at least one onboard lyophilized reagent.

15. The method of claim 13, wherein each receptacle includes protocol specific reagents specific to a protocol of each slide.

16. The method of claim 13, further comprising:
supplying reagents, by the plurality of common reagent stores, to the plurality of processing bays in parallel.

17. The method of claim 13, wherein each multiple input valve of a plurality of multiple input valves is dedicated to a respective receptacle bay, each input of a particular multiple input valve being capable of selecting a different common reagent store.

18. The method of claim 13, further comprising:
completing a portion of the receptacle, by the specimen slide, to form a chamber within the receptacle that stores the specimen.

19. The method of claim 13, wherein the plurality of common reagent stores includes at least one bulk reagent store.

20. The method of claim 13, further comprising:
receiving, by first and second receptacle bays in the plurality of receptacle bays, a reagent from one of the common reagent stores at the same time.

21. The method of claim 13, wherein each receptacle bay includes a manifold that receives a respective receptacle with specimen, wherein the manifold is fluidically coupled to a reagent port to supply a reagent to the respective receptacle.

22. The method of claim 21, wherein the manifold of each receptacle bay is fluidically coupled to a plurality of lyophilized reagent rehydration reagent or water lines to supply rehydration reagent or water to the respective receptacle of each respective receptacle bay.

23. The method of claim 13, further comprising:
controlling, by a thermoelectric cooler in each receptacle bay, the temperature of the specimen in the receptacle of each receptacle bay.

24. The method of claim 13, wherein a particular receptacle includes at least one reagent in lyophilized form.
